(19) United States
(12) Patent Application Publication
(10) Pub. No.: US 2026/0338494 A1
(43) Pub. Date: Oct. 29, 2026

(54) MULTI-STAGE THERMAL STORAGE DEVICE

(71) Applicant: Honeywell International Inc., Charlotte, NC (US)

(72) Inventors: Joseph Mead Jensen, Torrance, CA (US); Brenton Tsuyoshi Takahashi, Monrovia, CA (US)

(21) Appl. No.: 19/187,785

(22) Filed: Apr. 23, 2025

(51) Int. Cl. F28D 20/02; B64D 13/06

(52) U.S. Cl. CPC F28D 20/025; B64D 2013/0614; B64D 2013/0648

(57) ABSTRACT

A thermal storage device (TSD) includes a housing. The housing defines a cavity, a working fluid inlet at an upstream end, and a working fluid outlet at a downstream end. One or more working fluid passages are disposed in the cavity which fluidically connect the working fluid inlet and the working fluid outlet. A phase-change material (PCM) surrounds the one or more working fluid passages. The thermal storage device includes a first stage and a second stage. The second stage is downstream of the first stage and separated from the first stage. The first stage defines a first weight per unit of volume and the second stage defines a second weight per unit of volume. The first weight per unit of volume is lower than the second weight per unit of volume.

### TECHNICAL FIELD

The present disclosure relates to thermal storage devices and the optimization of the devices for improved performance

### BACKGROUND

Thermal storage devices may be used to cool systems that output a large amount of thermal energy in a transient thermal burst. A thermal storage device (TSD) may include a phase-change material (PCM) that may liquify during the burst of thermal energy thus absorbing the thermal energy and may solidify the PCM during a subsequent period of inactivity and cooling by using a secondary cooling loop. Working fluid may flow through or in close proximity to the TSD to transfer heat to the PCM in operation. The enthalpy of fusion of the PCM, along with the sensible heat of the PCM may enable the thermal storage device to absorb a relatively large amount of thermal energy. Thermal storage devices may be used on vehicles (e.g., aircraft) to cool a transient thermal load caused by certain aircraft systems and can be used on ground-based systems that experience high transient loads.

### SUMMARY

In general, the disclosure is directed to a thermal storage device (TSD) with multiple stages. The multi-stage thermal storage device includes at least two stages, but can include three, four, or even five stages. The first stage is configured as a lower density, lower-efficiency stage while the second stage is configured as a higher-efficiency, higher density stage. The multi-stage thermal storage device may thus reduce the overall weight of the thermal storage device relative to a single-stage thermal storage device, while simultaneously capturing thermal energy from a working fluid passing through the thermal storage device at high-efficiency.

In one or more examples, a thermal storage device includes a housing. The housing defines a cavity, a working fluid inlet at an upstream end, and a working fluid outlet at a downstream end. One or more working fluid passages are disposed in the cavity which fluidically connect the working fluid inlet and the working fluid outlet. A phase-change material (PCM) is surrounded by one or more working fluid passages, or the working fluid passages surround the PCM. The thermal storage device includes a first stage and a second stage. The second stage is downstream of the first stage and separated from the first stage or integral with the first stage. The first stage defines a first weight per unit of volume and the second stage defines a second weight per unit of volume. The first weight per unit of volume is lower than the second weight per unit of volume.

In one or more examples, a technique for manufacturing a thermal storage device includes forming a housing containing a cavity. The housing defines a working fluid inlet at an upstream end and a working fluid outlet at a downstream end. The technique further includes forming one or more working fluid passages within the cavity, where the one or more working fluid passages fluidically connecting the working fluid inlet and the working fluid outlet. The technique includes using the one or more working fluid passages in the cavity to surround the phase-change material (PCM). The technique also includes separating a first stage of the thermal storage device from a second stage of the thermal storage device, with the second stage downstream of the first stage. The first stage defines a first weight per unit of volume and the second stage defines a second weight per unit of volume. The first weight per unit of volume is lower than the second weight per unit of volume. The weight can include the weight of the PCM and the solid enclosure TSD weight.

In one or more examples, a thermal energy management system for an aircraft includes a working fluid circuit and a pump configured to circulate a working fluid through the working fluid circuit of the TSD which contains the PCM. A thermal storage device is a component within the working fluid circuit. The thermal storage device includes a housing. The housing defines a cavity, a working fluid inlet at an upstream end, and a working fluid outlet at a downstream end. One or more working fluid passages are disposed in the cavity which fluidically connect the working fluid inlet and the working fluid outlet. A phase-change material (PCM) is surrounded by one or more working fluid passages. The thermal storage device includes a first stage and a second stage. The second stage is downstream of the first stage and separated from the first stage. The first stage defines a first weight per unit of volume and the second stage defines a second weight per unit of volume. The first weight per unit of volume is lower than the second weight per unit of volume.

This summary is intended to provide an overview of the subject matter described in this disclosure. It is not intended to provide an exclusive or exhaustive explanation of the systems, devices, and methods described in detail within the accompanying drawings and description below. Further details of one or more examples are set forth in the accompanying drawings and the description below. Other features, objects, and advantages will be apparent from the description and drawings, and from the statements provided below.

### BRIEF DESCRIPTION OF THE FIGURES

FIG. 1 is a schematic diagram of a thermal energy management system, which, in some examples, is onboard a vehicle and includes an exemplary thermal storage device according to the present disclosure.

FIG. 2 is a conceptual perspective view illustrating a thermal storage device in accordance with one or more examples of the present disclosure, with hidden elements illustrated by broken lines.

FIG. 3 is a conceptual cross-sectional side view illustrating a thermal storage device that includes a first stage and a second stage downstream of the first stage, in accordance with one or more examples of the present disclosure.

FIG. 4 is a conceptual cross-sectional side view illustrating a thermal storage device that includes a first stage, second stage, and third stage, in accordance with one or more examples of the present disclosure.

FIGS. 5A–5D are conceptual cross-sectional side views illustrating an example thermal storage device during a first point in time, a second later point in time, a third point in time, and a fourth point in time during operation where the PCM is completely melted, respectively.

FIGS. 6–8 are conceptual cross-sectional side views illustrating different example thermal storage devices during operation.

FIG. 9 is a conceptual cross-sectional side view illustrating a thermal storage device that includes a first stage and a second stage, in accordance with one or more examples of the present disclosure.

FIG. 10 is a flowchart illustrating an example technique for manufacturing a thermal storage device, in accordance with one or more examples of the present disclosure.

FIG. 11 is a conceptual top view illustrating a vehicle which includes a thermal storage device, in accordance with one or more examples of the present disclosure.

### DETAILED DESCRIPTION

Modern aircraft may require the ability to reject relatively large amounts of thermal energy in a short timespan due to operation of certain aircraft systems. For example, certain propulsion operations, avionics, electrical equipment, and/or weapons systems may operate or include an operating mode that is engaged in short durations (e.g., seconds up to a few minutes) which generate a large amount of thermal energy that must be rejected from the cooling media, immediately followed by a relatively longer periods (e.g., several minutes to hours) of thermal inactivity. This period of inactivity can be used to passively or actively return the PCM to the solid state, thus allowing the TSD to be operated again.

A thermal storage device may be included in a thermal management system for a vehicle (e.g., aircraft), alone or in combination with other components. The thermal storage device may function to absorb the bursts of thermal energy from transient thermal loads by absorbing heat from a working fluid passing through working fluid passages formed in the thermal storage device with a phase-change material (PCM) that surrounds the working fluid passages. The amount and characteristics of the PCM may be selected to address the particular desired performance characteristics of the TSD such as melting temperature and thermal load capability. The TSD may be used to regulate the cooling fluid temperature within a thermal management system to the desired level, which may limit thermal excursions.

When in active operation, the PCM may change phases from a solid to a liquid, and the latent heat absorbed by the PCM during the phase change may allow for a relatively large amount of heat to be absorbed by the thermal storage device when compared to a other energy-absorbing materials that does not change phases during operation. The subsequent period of inactivity where the transient thermal load is not present may allow for the PCM to cool and solidify, either actively (e.g., by flowing cold fluid) or passively (e.g., allowing a return to thermal equilibrium within a cooler surrounding environment), preparing the thermal storage device for a subsequent burst of thermal energy.

Generally, the working fluid flows axially through the thermal storage device from a working fluid inlet at an upstream end to a working fluid outlet at a downstream end. The working fluid may define a single pass, multiple passes, or a complex pattern through the device. Since the working fluid is hottest at the inlet when the thermal load is present, the PCM may not be fully melted at the start of excursion. Conversely, the working fluid is the coolest at the outlet. The thermal storage device generally operates most efficiently toward the upstream end during the early part of the operation, liquifying the PCM positioned in this region first. In certain thermal storage devices, which do not account for the changing characteristics of the working fluid as it passes through the length of the thermal storage device throughout operation, the “working length” of the thermal storage device, where a large portion of the heat transfer from the working fluid to the PCM takes place, may be shorter than the actual length of the thermal storage device. Instead, the working length of thermal storage device may migrate from the upstream end to the downstream end during the burst of thermal energy that is quenched by the device though out the thermal loading.

Furthermore, and especially when employed in applications on vehicles such as aircraft, it may be desirable for a thermal storage device to weigh as little as possible while still quenching the transient thermal load. The envelope of the TSD may also be a significant performance parameter. In some examples, the thermal storage device may need to weigh less than a threshold maximum weight to be included on a vehicle. Even when meeting a threshold maximum weight, further reducing the weight of a thermal storage device may be desirable. Alternatively, the unit size can be increased to obtain more thermal energy absorbing performance. For example, reducing the weight of the thermal storage device may improve the fuel efficiency or operational range of a vehicle. One way to reduce weight of a thermal storage device is to reduce the amount of phase-change material that is included, but such efforts may reduce the amount of thermal energy that the thermal storage device is able to absorb.

Another way to reduce weight of a thermal storage device is to reduce the amount of structure included in the device. For example, the working fluid may pass through a plurality of passages, which may be defined by tubes, or plates and fins, or (other heat transfer surfaces such as foam, pin fins, microchannels, additive surfaces) the like. Removing a number of tubes (or plates/fins, baffles, or the like) which define the plurality of passages may reduce the weight of the thermal storage device, but such efforts will reduce the efficiency of heat transfer within the device. In some examples, a device with too few passages, and thus too little surface area for heat transfer to occur between the working fluid and the PCM, may result in “thermal bleed through,” a condition where the working fluid passing through the thermal storage device and exiting the working fluid outlet while not being reduced in temperature to the target temperature.

Yet another way to reduce weight of a thermal storage device is to replace the materials of heat transfer structures (e.g., tubes, plates/fins, or the like) with lighter weight materials. For example, it may be desirable to replace metal tubes with plastic tubes, which may be lighter in weight. However, passages defined by lightweight materials (e.g., plastic) may have lower thermal conductance than similar passages defined by heavier materials, which are typically metallic (e.g., copper, aluminum, steel, or the like). This lower conductance will reduce the thermal efficiency but the weight improvement can make this design feature desirable.

Thermal storage devices of the present disclosure may address one or more of the challenges described above. In some examples, the disclosure relates to a multi-stage thermal storage device that may enable management of large, temporary loads of thermal energy while simultaneously reducing deleterious impacts of additional weight. Multi-stage thermal storage devices disclosed herein may include a first stage and a second stage. The first stage may have less total weight per unit of volume when compared to the second stage. Accordingly, the first stage may function as a low density, less efficient stage while the second stage may function as a high-efficiency, high density stage.

The difference in weight per unit of volume may be due to differences between the stages in geometry, materials, or both. Differences in the geometry between the first stage and the second stage may be due to the number or arrangement of working fluid passages through the thermal storage device and the adjoining structure to the PCM. These differences may result in the second stage having a greater amount of surface area for heat transfer per unit volume than the first stage. Additionally, or alternatively, materials may be selected such that the first stage is lightweight when compared to the second stage, even if that means the first stage has relatively lower heat transfer efficiency than the second stage, which may include a high-thermal conductance and heavier weight than the first stage. Optionally, one or more intermediate stages may be disposed between the first stage and the second stage. Where one or more intermediate stages are included, the intermediate stage or stages may define a weight per unit of volume between the first stage and the second stage.

Multi-staged thermal storage devices described herein may be significantly lighter than similar single-stage thermal storage device that absorb a similar amount of thermal energy. This is due to the fact that a single-stage device must be designed to achieve the temperature reduction at the last moments of operation. Thus, the high efficiency, high density design is propagated throughout the full TSD geometry. For example, thermal storage devices described herein may be at least 15%, or even at least 30% lighter than a single-stage thermal storage device configured to absorb the same amount of thermal energy. Furthermore, in some examples, thermal storage devices described herein, which include a high-efficiency stage as a last stage of the device, will reduce and may eliminate bleed through at the outlet.

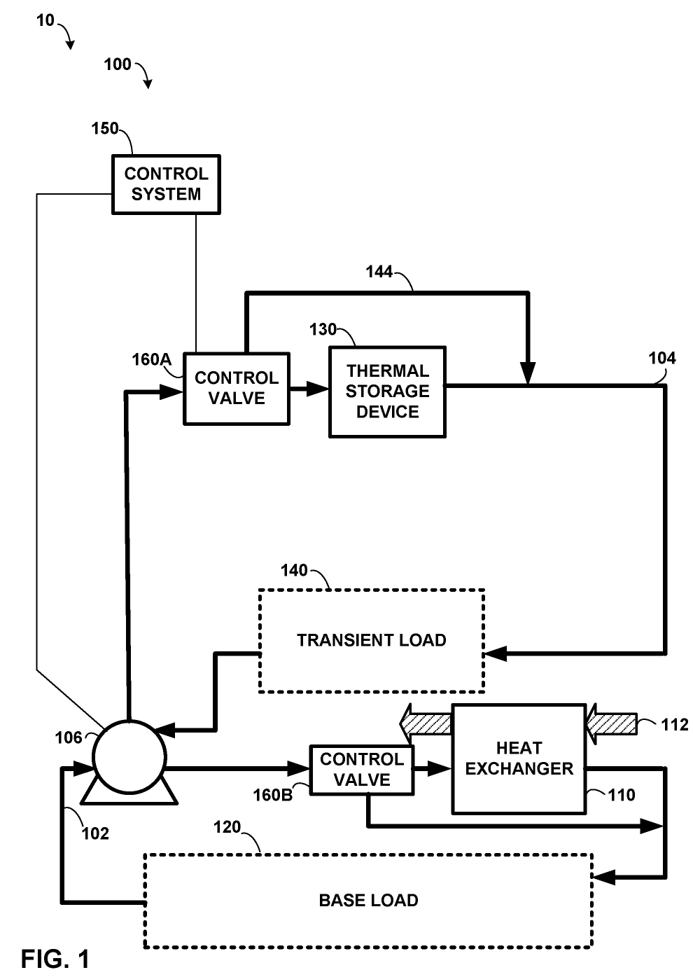

FIG. 1 is a schematic diagram of thermal energy management system 100. Thermal energy management system 100 may be onboard vehicle 10. Vehicle 10 may be a ground vehicle, marine vehicle, or an airborne vehicle such as an aircraft. Thermal energy management system 100 may also be included on a ground, stationary application.

Thermal energy management system 100 cools components of vehicle 10 during operation. Thermal energy management system 100 includes cooling loops 102, 104, which contain a working fluid driven by pump 106. Although illustrated as integrated into the same system, cooling loops 102, 104 may be separate loops not fluidically connected with each other, with each loop driven by a separate pump. Alternatively, a single cooling loop may include the components of both cooling loops 102, 104.) The working fluid flowing inside cooling loops 102, 104 may include water, an oil, a refrigerant, a thermal transport fluid, fuel, air, or combinations thereof.

Thermal energy management system 100 includes control valves 160A, 160B, which may be actuated by control system 150 to direct working fluid through either or both of cooling loops 102, 104. In some examples, control system 150 may close control valves 160A such that working fluid may only flow through cooling loop 102 during normal operations of vehicle 10.

Cooling loop 102 includes heat exchanger 110 and base load of thermal energy 120. Pump 106 may circulate working fluid through cooling loop 102 to receive thermal energy from base load of thermal energy 120 and dump the received thermal energy at heat exchanger 110 to cool one or more components of vehicle 10. In some examples, heat exchanger 110 may include cooling fluid 112 in a counter-current arrangement, as illustrated, but other arrangements are other considered. Cooling fluid 112 may be include water, an oil, a refrigerant, a thermal transport fluid, fuel, ram air, bleed conditioned air, or combinations. Base load of thermal energy 120 may include thermal energy generated during operation of vehicle 10 by pumps, engines, motors, controllers, avionics, cabin air systems, batteries and the like. Base load of thermal energy 120 includes components that generate thermal energy relatively consistently and do not include sudden, temporary surges of thermal energy which could overwhelm heat exchanger 110.

Cooling loop 104 includes transient load of thermal energy 140 and thermal storage device 130 which is configured to absorb thermal energy generated by transient load of thermal energy 140. In some examples, as illustrated, cooling loop 104 may optionally include an arrangement where thermal storage device 130 may be bypassed by control of control valves 160 such that working fluid is directed around thermal storage device 130 into bypass line 144.

Transient load of thermal energy 140 may include a temporary burst of thermal energy generated by certain systems or modes of operation from propulsion operations, avionics, electrical equipment, and/or weapons systems. In some examples, the thermal energy generated by transient load of thermal energy 140 may be at least about 50 kilowatts (kW), or at least about 100 kW, or at least about 250 kW, or at least about 500 kW or higher. In some examples, transient load of thermal energy 140 may be activated for a period of 10 secs, 30 seconds, 1, 2 or 3 or even 5 minutes. In some examples, the thermal energy may be generated in pulses of several seconds, as short as 2 or 3 seconds and as long as about 10 to 15 seconds, such that the activation period of 1, 2 or 3 or even 5 minutes can be spread out over periods of 5 to 30 minutes. In some examples, the active period of transient load of thermal energy 140 may be followed by a subsequent longer period of inactivity. The period of inactivity may be at least about 1 minute, 10 minutes, or at least about 30 minutes, or at least about 1 hour, or at least about 2 hours. The term “about,” as used herein, includes the stated value plus or minus 10% of the stated value.

Cooling loop 104 includes thermal storage device 130. Thermal storage device 130 contains phase-change material (PCM) within a cavity defined by a housing of the device. The PCM inside thermal storage device 130 absorbs the transient load of thermal energy 140, changing phases from solid to liquid as the energy is absorbed when the fluid temperature is above the melt temperature. The PCM may include any suitable PCM, such as one or more of water, salt and salt hydrates, metallics, organic compounds such as paraffins or fatty acids, polymeric material such as poly(ethylene glycol), eutectics combing two or more PCM materials, or the like. In some examples, the PCM may have a phase transition temperature between about 10°C. and 20°C. The melt temperature of the PCM is selected such that the controlled outlet temperature is satisfactory for the system operation. That is, a PCM melt temperature of 50°C would not be used if the control temperature was to be 20 °C. In some examples, the PCM may have a phase change material energy density of above about 200 kJ/kg of latent heat. In some examples, the PCM may have a density of at least about 1 g/cc, or at least about 1.1 g/cc, or at least about 1.2 g/cc, 1.3 g/cc, 1.4 g/cc, which may make the PCM volume effective.

In accordance with one or more aspects of the present disclosure, thermal storage device 130 may be a multi-stage thermal storage device. Thermal storage device 130 may include any suitable number of stages, including two stages, three stages, four stages, or five stages. Arranging thermal storage device 130 in multiple stages may enable thermal storage device 130 to be lighter than otherwise possible in a single stage device, which may improve the fuel efficiency and performance of vehicle 10. Furthermore, arranging thermal storage device 130 in multiple stages may enable inclusion of a high-efficiency stage in a downstream region adjacent to a downstream end, which may reduce the occurrence or severity of a thermal bleed through event.

In some examples, thermal storage device 130 may include a housing which contains a cavity that stores the PCM. The housing may define a working fluid inlet at an upstream end and a working fluid outlet at a downstream end. One or more working fluid passages may be disposed in the cavity and fluidically connect the working fluid inlet and the working fluid outlet. The working fluid passages may be surrounded by the PCM. The multi-stage thermal storage device 130 includes at least a first stage and a second stage. The second stage is downstream of the first stage and separated from the first stage. The first stage defines a first weight per unit of volume, while the second stage defines a second weight per unit of volume. The first weight per unit of volume is lower than the second weight per unit of volume. Thus, multi-stage thermal storage device 130 may provide both a lighter and higher performing thermal storage device relative to device which include only a single stage.

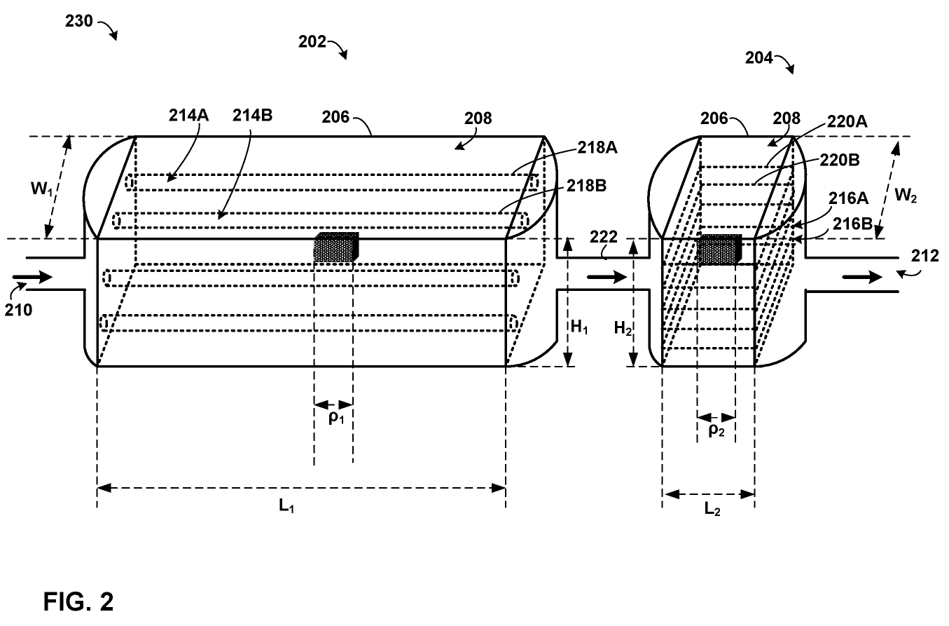

FIG. 2 is a conceptual perspective view illustrating thermal storage device 230, with hidden elements illustrated by broken lines. Thermal storage device 230 of FIG. 2 may be a more detailed example of thermal storage device 130 of FIG. 1. Thermal storage device 230 is a multi-stage thermal storage device which includes first stage 202 and second stage 204. Second stage 204 is downstream of and separated from first stage 202 in this figure. Thermal storage device 230 may be arranged as a shell-and-tube type device, a tube bundle device, a plate-fin device, an additively-constructed device, or another type of device. Thermal storage device 230 may be constructed as a brazed or welded structure or as an additively manufactured assembly or by any other acceptable method. In some examples, as illustrated, first stage 202 may be arranged as a shell-and-tube device, and second stage 204 may be a plate fin device, or vice versa. Only the plates of second stage 204 are illustrated for clarity. Only the tubes of the first stage are shown.

Thermal storage device 230 includes working fluid inlet 210 and working fluid outlet 212. Working fluid flows in axial direction A through thermal storage device 230 from working fluid inlet 210 to working fluid outlet 212, as illustrated by the block arrows. In thermal storage device 230, working fluid flows through first stage passages 214A, 214B (collectively, “first stage passages 214”) and through second stage passages 216A, 216B (collectively, “second stage passages 216”) between working fluid inlet 210 at the upstream end and working fluid outlet 212 at the downstream end. Tubes 218A, 218B (collectively, “tubes 218”) may define first stage passages 214, while plates 220A, 220B (collectively “plates 220”) and fins (not illustrated for clarity) may define second stage passages 216. Put differently, a surface of tube 218A may define first stage passage 214A, and the plates and fins of second stage 204 may define second stage passages 216.

Thermal storage device 230 includes housing 206 which defines cavity 208 containing the PCM. Passages 214, 216 run through cavity 208 to fluidically connect working fluid inlet 210 to working fluid outlet 212. PCM (not illustrated) fills cavity 208 surrounding some or all of the first stage passages 214 in first stage 202, and the same or a potentially different PCM (not illustrated) fills cavity 208 surrounding second stage passages 216 in second stage 204. In operation, the PCM may receive thermal energy transferred from the working fluid flowing through thermal storage device 230 to absorb the thermal energy generated by a transient load (140, FIG. 1), changing phases from an initially solid state to a liquid state.

In some examples, first stage 202 may be separated from second stage 204 by length of tube 222, although in other examples, first stage 202 may be separated from second stage 204 by direct connection of the housing 206 of the first stage to the housing 206 of the second stage.

First stage 202 is configured as a low density stage while second stage 204 is configured as a high-efficiency stage, such that thermal storage device 230 provides both overall lightweight and high-performance properties relative to a similar device arranged as a single stage.

In some examples, first stage 202 may define first weight per unit of volume ρ₁. Second stage 204 may define second weight per unit of length ρ₂. In some examples, ρ₁ may be less than ρ₂. For example, ρ₁may be no more than 50%, or no more than 75%, of ρ₂ for a weight/performance optimized system. The reduced weight per unit of volume of first stage 202 relative to second stage 204 may be due to differences in the geometry of the internal structure of first stage 202 and second stage 204. For example, first stage 202 may define a weight per unit of volume of less than about 1.1 grams per cubic centimeter, when both the PCM and the structure of first stage 202 is considered in total. Second stage 204 may define a weight per unit of volume of more than about 1.1 grams per cubic centimeter, when both the PCM and the structure of first stage 204 is considered in total. Thus, multi-stage thermal storage device 130 may provide both a more weight-compliant and high performing thermal storage device relative to device which include only a single stage.

In some examples, the differences between first stage 202 and second stage 204 may be defined in terms of heat absorbed per unit of total weight. For example, first stage 202 may define a first amount of heat absorbed per unit of weight (e.g., kilowatts absorbed per kilogram). Second stage 204 may define a second amount of heat absorbed per unit of weight. The first amount of heat absorbed per unit of weight may be greater than the second amount as the weight benefit of the first stage is substantial. As mentioned above, the weight of each of first stage 202 and second stage 204 may be determined by weighing the PCM and structure together to obtain the total weight.

Second stage 204 may be relatively more efficient in transferring thermal energy to the PCM than first stage 202, and relatively heavier than first stage 202, by inclusion of more surface area for heat transfer than first stage 202. For example, as illustrated, first stage passages 214 may be defined by tubes 218, while second stage passes 216 may be defined by plates 220 and fins within the coolant path as well as the within the PCM passage (not illustrated for clarity). Arranging first stage 202 as a tube bundle or shell and tube type device and second stage 204 as a plate-fin type device may result in second stage 204 having more surface area for heat transfer than first stage 202. The surface area for heat transfer may be defined as any surface area that separates the working fluid from the PCM. The addition of fin area within the PCM will increase the weight but will improve the performance.

Although first stage 202 may be arranged as a different type of device or made from a different material of construction than the second stage 204, the multiple stages of thermal storage device 230 may be the same type of device, e.g., both first stage 202 and second stage 204 are tubular type, or both first stage 202 and second stage 204 are plate-fin type. In such examples, the number of second stage passages 216 may be greater than the number of first stage passages 214. The greater number of passages in second stage 204 may result in more surface area for heat transfer per unit volume in second stage 204 than in first stage 202 resulting in a better efficiency for the second stage. In some examples, second stage 204 may define more than twice as much heat transfer surface area per unit of volume than first stage 202 especially when including the area of the fins. As such, second stage 204 may both relatively heavier and relatively more efficient than first stage 202.

In some examples, as described elsewhere herein, one or more intermediate stages may be disposed between first stage 202 and second stage 204. In examples where one or more intermediate stages are present, the intermediate stages may define a weight per unit length, a density, and/or a heat transfer surface area per unit of volume that is between the values defined by first stage 202 and second stage 204.

The particular application of thermal storage device results in a complex analysis that depends on a number of factors including the particular PCM chosen, the PCM melt temperature, the working fluid flowrate, the allowed working fluid pressure drop, the heat absorption and release cycle duty, and the like. However, a general rule of thumb is that the amount of thermal energy that thermal storage device 230 can receive during a burst of thermal energy is approximately proportional to the amount of PCM that is included. Put differently, more PCM generally enables the absorption of more thermal energy absent the constraint of transient response. The disposition of the PCM between first stage 202 and second stage 204 impacts the amount of weight savings that are possible by inclusion of multi-stage thermal storage device 230 over a similar single-stage device. It may be desirable to make first stage 202 relatively larger than second stage 204 since first stage 202 is generally lighter and/or less dense than second stage 204 and this results in a lighter total unit. Since the working flow will flow through the first stage is at the hottest temperature for all of the active phase, the heat can be released into that first stage over a longer time while letting the second stage to perform the last portion of the heat transfer.

In some examples, first stage 202 may define a first volume of PCM, and second stage 204 may define a second volume of PCM. The first volume may be larger than the second volume. For example, assuming a rectilinear PCM configuration, first stage 202 may define a first axial length L₁, width W₁, and height H₁. The product of first stage dimensions length L₁, width W₁, and height H₁may be first stage volume V₁. Similarly, second stage 204 may define a second axial length L₂, second width W₂, and second height H₂. The product of second stage dimensions length L₂, width W₂, and height H₂may be second stage volume V₂.

In some cases, volume V₁, may be at least about 1.5 times larger than second stage volume V₂, or at least about 3 times larger than V₂. The larger volume of PCM of first stage 202 may result in reduced weight of thermal storage device 230 overall, because a higher fraction of the PCM may be packaged in the lightweight arrangement of first stage 202. Inclusion of second stage 204, configured as a relatively small high-efficiency stage, may ensure that bleed through events are reduced in occurrence or magnitude, thus maintaining the performance of thermal storage device 230 even as its weight is reduced by at least 15%, or at least 30%, or at least 40%, relative to a thermal storage device containing the same total volume of PCM arranged solely as second stage 204. In some examples, thermal storage device 230 is configured to absorb a maximum amount of thermal energy before all of the PCM changes in state from completely solid to completely liquid, and first stage 202 may be configured to absorb at least 70 percent of the maximum amount of thermal energy.

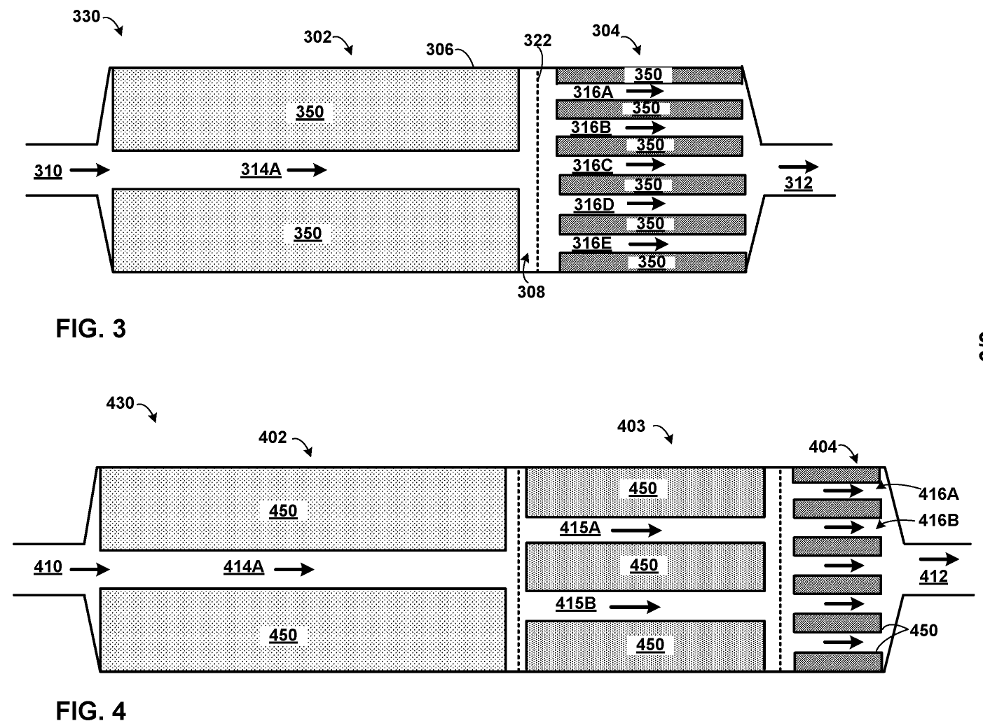

FIG. 3 is a conceptual cross-sectional side view illustrating thermal storage device 330. Thermal storage device 330 may be an example of thermal storage device 130 of FIG. 1 or thermal storage device 230 of FIG. 2. Thermal storage device 330 of FIG. 3 may described similarly to thermal storage device 230 of FIG. 2, differing as described herein, where similar reference numerals indicate similar elements.

Thermal storage device 330 includes working fluid inlet 310 at an upstream end and working fluid outlet 312 at a downstream end. Thermal storage device 330 includes housing 306 which defines cavity 308. Cavity 308 may include PCM and working fluid passages. Cavity 308 is partially filled by phase-change material (PCM) 350 surrounding a working fluid passages or passages. In operation, working fluid flowing through the working fluid passage or passages receives thermal energy from a transient load (140, FIG. 1), transfers the received thermal energy to PCM 350 at thermal storage device 330, and is recirculated through a cooling loop (104, FIG. 1) to repeat the process to cool one or more components of a vehicle (10, FIG. 1).

Thermal storage device 330 is configured as a multi-stage thermal storage device. As such, thermal storage device 330 includes first stage 302 and second stage 304 connected to each other and housed with common housing 306. In some examples, perforated wall 322 may separate first stage 302 from second stage 304 within housing 306. In some examples, the first stage 302 may be completely separated from the second stage 304. First stage 302 includes passage 314A, which routes working fluid through first stage 302 as the working fluid transfers thermal energy to PCM 350. Second stage 304 includes second stage passages 316A, 316B, 316C, 316D, 316E (collectively, “second stage passages 316”). As a multi-stage device, thermal storage device 330 may enable both lightweight and high-performance capabilities relative to a single-stage thermal storage device.

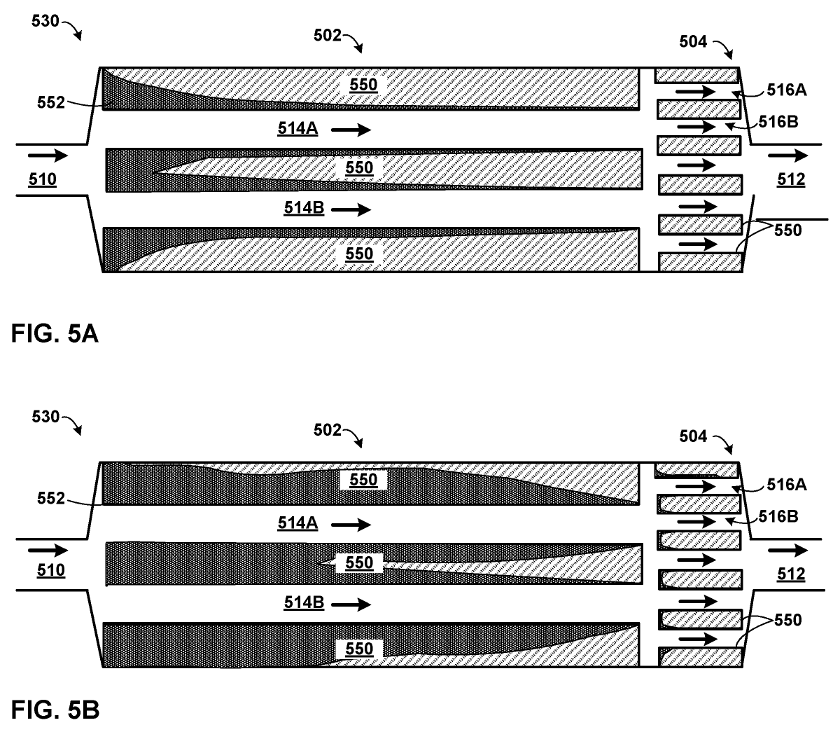

FIG. 4 is a conceptual cross-sectional side view illustrating thermal storage device 430. Thermal storage device 430 may be an example of thermal storage device 130 of FIG. 1, thermal storage device 230 of FIG. 2, or thermal storage device 330 of FIG. 3. Thermal storage device 430 of FIG. 4 may described similarly to thermal storage device 330 of FIG. 3, differing as described herein, where similar reference numerals indicate similar elements.

Thermal storage device 430 of FIG. 4 includes intermediate stage 403 disposed between first stage 402 and second stage 404. Intermediate stage 403 may include intermediate stage passages 415A, 415B (collectively, “intermediate stage passages 415”) surrounded by PCM 450.

Intermediate stage 403 may have properties that lie between those properties defined by first stage 402 and second stage 403. For example, first stage 402 may define a number of first stage passages 414, and second stage 404 may define a number of second stage passages 416. Alternatively, first stage 402 and second stage 404 may contain different materials or configurations of the PCM enclosed. The number of intermediate stage passages may be between the number of first stage passages and the number of second stage passages. Similarly, and as described above, first stage 402 may define a first weight per unit of volume, and second stage 404 may define a second weight per unit of volume. Intermediate stage 403 may define a weight per unit of volume that is between the first weight per unit of volume and the second weight per unit of volume. This weight change could be driven by use of more fins or thermally conducting elements within the PCM. Accordingly, the intermediate stage may define an intermediate amount of surface area for heat transfer. As such, thermal storage device 430 which includes three stages may be relatively more efficient and lighter overall than a two-stage device. In some examples, further benefits may be realized as the number of stages in further increased to four stages, or even to five stages. However, the manufacturing complexity may increase as the number of stages increases, so there may be decreasing marginal utility to further stages beyond a certain point. In some examples, keeping the number of passages the same while changing the detailed fin or thermal conducting element configuration in the PCM and the working fluid may allow for a simpler manufacturing process.

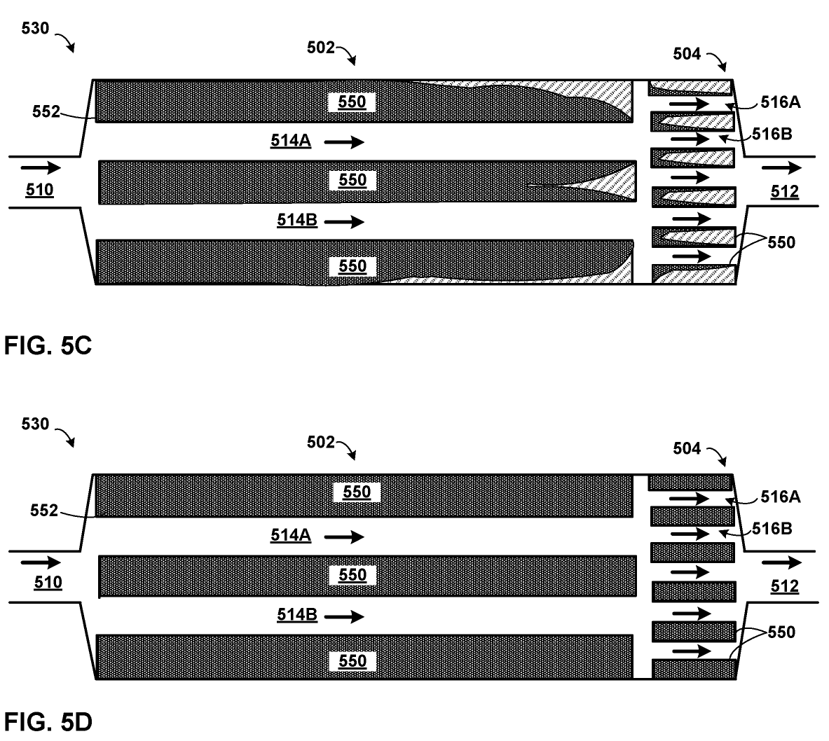

FIGS. 5A–5D are conceptual cross-sectional side views illustrating thermal storage device 530. Thermal storage device 530 is illustrated at a first point in time during an early part of a burst of thermal energy in FIG. 5A, at a second point in time further along during a burst of thermal energy in FIG. 5B, at a third point in time still further along during a burst of thermal energy in FIG. 5C, and at a fourth point in time at a conclusion of a burst of thermal energy in FIG. 5D. Thermal storage device 530 may be an example of any of the thermal storage devices described above, where similar reference numerals indicate to similar elements. It should be noted that the thermal energy that is being released into the storage device 530 may be from a single thermal burst or from successive bursts with relatively small periods of non-active time between the bursts.

Thermal storage device 530 includes first stage 502 and second stage 504. In operation, working fluid enters working fluid inlet 510, passes through first stage 502 via first stage passages 514, passes through second stage 504 via second stage passages 516, and exits working fluid outlet 512. The working fluid melts PCM 550 into liquid PCM 552 during operation. Solid PCM 550 is illustrated by cross-hatching, while liquid PCM 552 is illustrated as the darker color in FIGS. 5A–5D.

The working fluid may be at the highest temperature at working fluid inlet 510 and may decrease to a lowest temperature at working fluid outlet 512 as it passes through thermal storage device 530. The outlet temperature may be below a threshold temperature, above which components of a vehicle (10, FIG. 1) cooled by thermal storage device 530 may overheat and fail. The transfer of thermal energy from the working fluid to PCM 550 may be at least partly based on the difference in temperature of the working fluid to the temperature of PCM 550.

Thermal storage device 530 includes second stage 504. Second stage 504 is downstream of first stage 502 and is different than first stage 502. For example, second stage 504 may include more surface area for heat transfer per unit volume than first stage 502 as illustrated, or may have walls defining passages that have a higher conductance than first stage 502, or may have a different PCM 550 surrounding second stage passages than first stage 502, or a combination of these differences. In any event, the difference or differences between first stage 502 and second stage 504 may result in second stage 504 having a less weight per unit of volume than first stage 502. Inclusion of second stage 504 in thermal storage device 530 may result in a thermal storage device that transfers thermal energy more efficiently between the working fluid and PCM 550 than a single stage thermal storage device arranged only as lightweight first stage 502.

As discussed above, thermal storage device 530 may be configured to quench or absorb a total amount of thermal energy during operation of absorbing energy while PCM 550 undergoes a phase change from solid to liquid. FIG. 5A depicts thermal storage device 530 during an early part of a burst of thermal energy, when approximately 25% of the total amount of thermal energy has been absorbed by PCM 550. As illustrated, PCM 550 in the first portion of first stage 502 may be absorbing a majority of the thermal energy and most of the PCM melting is within that first stage.

FIG. 5B depicts thermal storage device 530 at a second point in time further along during the burst of thermal energy. At the second point in time illustrated in FIG. 5B, approximately 50% of the total amount of thermal energy capacity of thermal storage device 530 has been exhausted, and PCM 550 located in high-efficiency second stage 504 has just begun to melt and most of the PCM melting is occurring in the first stage.

FIG. 5C depicts thermal storage device 530 at a third point in time further along during the burst of thermal energy. At the third point in time illustrated in FIG. 5C, approximately 75% of the total amount of thermal energy capacity of thermal storage device 530 has been exhausted. PCM 550 located in high-efficiency second stage 504 has a significant portion of PCM 550 still in the solid phase, which reduces the likelihood of a thermal bleed through event.

FIG. 5D depicts thermal storage device 530 at or near the end of a burst of thermal energy. At the fourth point in time illustrated in FIG. 5D, PCM 550 in first stage 502 and PCM 550 in second stage 504 may reach a completely liquid phase.

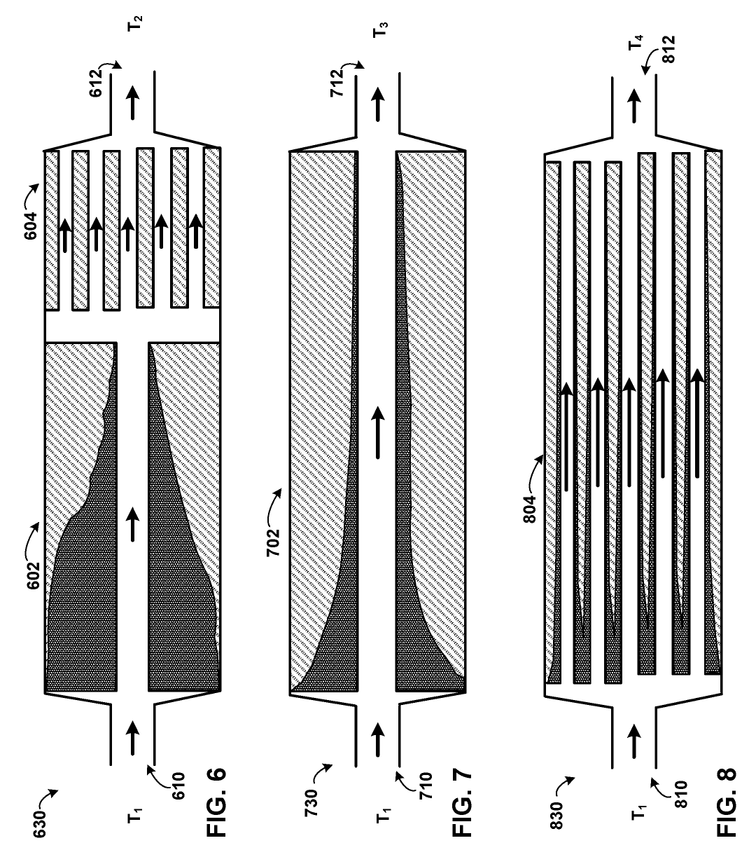

FIGS. 6–8 are conceptual cross-sectional side views illustrating example thermal storage devices 630, 730, 830 during operation, respectively. Thermal storage device 630 of FIG. 6 is a multi-stage thermal storage device. Thermal storage device 630 may be an example of any of the above-described thermal storage devices, and may be described similarly, where similar reference numerals indicate similar elements. Thermal storage device 730 of FIG. 7 is of similar size and volume to thermal storage device 630. Thermal storage device 730 is a single stage device which includes only one stage 702 arranged similarly to first stage 602 of thermal storage device 630. Thermal storage device 830 of FIG. 8 is of similar size and volume to thermal storage device 630 of FIG. 6 and thermal storage device 730 of FIG. 7. Thermal storage device 830 of FIG. 8 includes only one stage 804 arranged with properties similar to second stage 604 of thermal storage device 630.

With reference to FIG. 6, in operation, working fluid enters thermal storage device 630 at working fluid inlet 610 at temperature T₁. Working fluid passes through working fluid passages in first stage 602 and second stage 604 before exiting thermal storage device 630 at working fluid outlet 612 at temperature T₂. Temperature T₂may be below a threshold temperature. In some examples, the threshold temperature may be the temperature above which the system or components of a vehicle (10, FIG. 1) cooled by thermal storage device 630 may overheat in a way that impacts performance or longevity of the component.

Thermal storage device 730 of FIG. 7 has similar length and volume when compared to thermal storage device 630 of FIG. 6. However, thermal storage device 730 includes only one stage, stage 702, which has the same geometry (e.g., arrangement and number of passages) as first stage 602 of thermal storage device 630. Although thermal storage device 730 may be lighter in weight than thermal storage device 630 because it includes less structure, thermal storage device may operate at reduced efficiency relative to thermal storage device 630. As a result, thermal storage device 730 may outlet working fluid at temperature T₃. In some cases, especially near the end of the transient thermal event, temperature T₃ may be higher than temperature T₂, and may be higher than the threshold temperature required to keep components below a failure temperature. Such a condition may be referred to as a thermal bleed through condition or a bleed through event. Even though thermal storage device 730 has PCM that has not yet liquified, and thus has heat capacity available to absorb heat from the working fluid, the lightweight structure of stage 702 may not be efficient enough to prevent bleed through and to control the outlet temperature to the desired level in a transient manner, that is T₂. As such, multi-stage thermal storage device 630 may be desirable when compared to single-stage thermal storage device 730.

Thermal storage device 830 of FIG. 8 has similar length and volume when compared to thermal storage device 630 of FIG. 6. However, thermal storage device 830 includes only one stage, stage 804, which has the same geometry (e.g., arrangement and number of passages) as second stage 804 of thermal storage device 830. Thermal storage device may outlet working fluid at temperature T₄. In some cases, temperature T₄ may be lower than temperature T₂, and accordingly lower than the threshold temperature required to keep components below a maximum desired temperature. However, such further reductions in temperature may not be necessary to keep components from failing. Furthermore, even though thermal storage device 830 may be relatively more efficient than thermal storage device 630, thermal storage device may be relatively substantially heavier than thermal storage device 630 due to the additional structure required to form the increased number of passages or increase heat transfer capabilities along the whole length of the TSD. Additionally, since the cavity is relatively more filled with passage-forming structures than PCM when compared to thermal storage device 630, thermal storage device 830 may have a reduced overall heat capacity relative to thermal storage device 630. Therefore, this configuration may not be able to absorb the full desired thermal load with a fixed volume. As such, multi-stage thermal storage device 630 may be desirable when compared to single-stage thermal storage device 830.

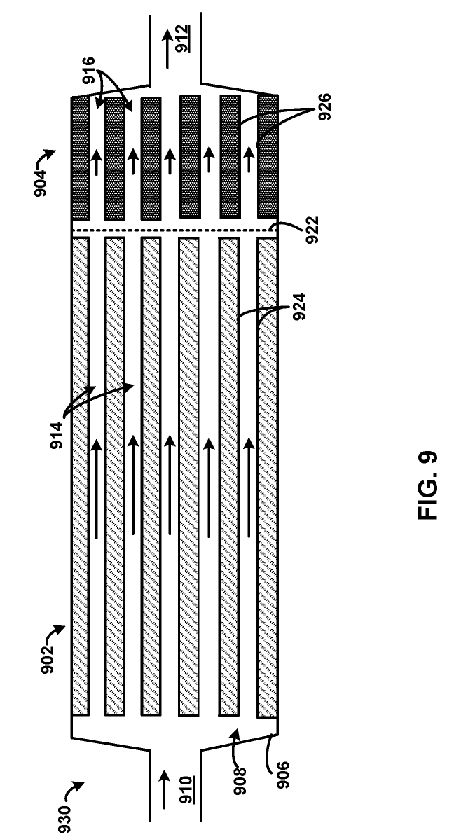

FIG. 9 is a conceptual cross-sectional side view illustrating a thermal storage device 930. Thermal storage device 930 may be an example of thermal storage device 130 of FIG. 1, thermal storage device 230 of FIG. 2, thermal storage device 330 of FIG. 3, thermal storage device 430 of FIG. 4, thermal storage device 530 of FIGS. 5A–5B, or thermal storage device 630 of FIG. 6. Thermal storage device 930 may be described similarly to the above devices, differing as described below, where similar reference numerals indicate similar elements.

Thermal storage device 930 includes working fluid inlet 910 and working fluid inlet 912. Working fluid inlet 910 and working fluid outlet 912 are fluidically connected by first stage passages 914 through first stage 902 and second stage passages 916 through second stage 904. First stage 902 and second stage 904 may be separated by perforated wall 922 or integrated into a single unit. Alternatively, an open working fluid chamber may separate first stage 902 and second stage 904.

In some examples, as illustrated, multi-stage thermal storage device 930 includes first stage 902 and second stage 904 that include the same geometry (e.g., arrangement and number of passages). Instead of differences in geometry, first stage 902 may have less weight per unit of volume than second stage 904 by inclusion of different materials.

For example, passages 914 of first stage 902 may be defined by first stage walls 924. First stage walls 924 may include a lightweight material. In some examples, such a lightweight material may have less thermal conductivity than a heavier material, which may have higher thermal conductivity. As such, first stage walls 924 may define a low overall thermal conductance from the working fluid to the PCM. For example, first stage walls 924 may include a plastic such as one or more of polyethylene, acrylonitrile butadiene styrene, polyvinyl chloride, or the like. Passages 916 of second stage 904 may be defined by second stage walls 926. Second stage walls 926 may define a high thermal conductance. In some examples, second stage walls 926 may include a metal or an alloy. This difference is indicated by the darker color of second stage 904 relative to first stage 902 in the illustration of FIG. 9. The conductance may also be driven by the detailed design of the unit including the use of additional fin structure within the PCM passages.

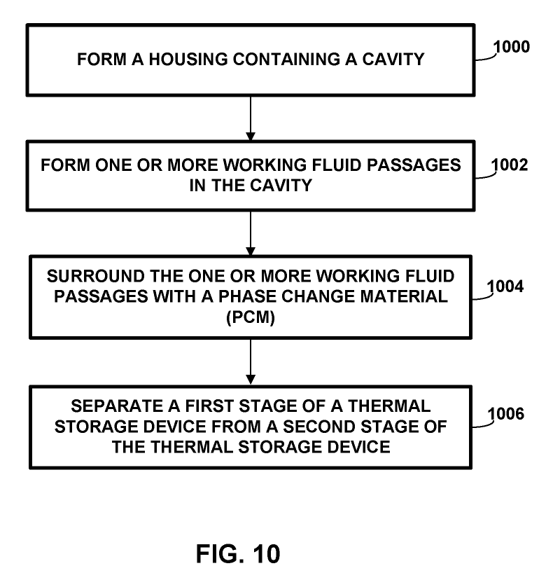

FIG. 10 is a flowchart illustrating an example technique for manufacturing a thermal storage device, in accordance with one or more examples of the present disclosure. The illustrated techniques may be used to manufacture thermal storage device 130 of FIG. 1, or any of the other thermal storage devices described herein. However, the illustrated technique of FIG. 10 may be used to manufacture other devices, and the described devices may be manufactured using other techniques. The illustrated technique of FIG. 10 will be described primarily with respect to thermal storage device 230 of FIG. 2.

The technique includes forming housing 206 which contains cavity 208 (1000). Housing 206 defines working fluid inlet 210 at an upstream end and working fluid outlet 212 at a downstream end. The technique includes forming one or more working fluid passages 214, 216 in cavity 208 (1002). One or more working fluid passages 214, 216 fluidically connect working fluid inlet 210 and working fluid outlet 212.

The technique also includes surrounding working fluid passages 214, 216 in cavity 208 with a phase-change material (PCM) (350, FIG. 3). The technique of FIG. 10 also includes separating first stage 202 of thermal storage device 230 from second stage 204. Second stage 204 is downstream (relative to the direction of working fluid flowing through the thermal storage device) of first stage 202. In some examples, first stage 202 may be separated from second stage 204 by length of tube 222. In some cases, first stage 202 may be separated from second stage 204 by a perforated wall (322, FIG. 3), although a distinct separation is not necessary. For example, the first stage may blend into the second stage.

In some examples, first stage 202 defines first stage total weight per unit of volume ρ₁ and second stage 204 defines second stage weight per unit of volume ρ₂. In some examples, ρ₁may be lower than ρ₂. In some examples, the weight percentage of the PCM material in first stage 202 may be a greater fraction of the total weight of first stage 202 than the weight percentage of PCM material in second stage 204 relative to the total weight.

In some examples, first stage 202 defines a first geometry as a first arrangement, number, and shape of first stage passages 214. Second stage 204 defines a second geometry as a second arrangement, number, and shape of second stage passages 216. The first geometry may be different than the second geometry. In some examples, first stage 202 may define a first volume V₁, and second stage 204 may define a second volume V₂. In some examples, first volume V1 may be larger than second volume V₂. In some examples, first stage 202 may be constructed according to a first technique, for example additive manufacturing. Second stage 204 may be constructed to a second technique, for example subtractive manufacturing or assembly.

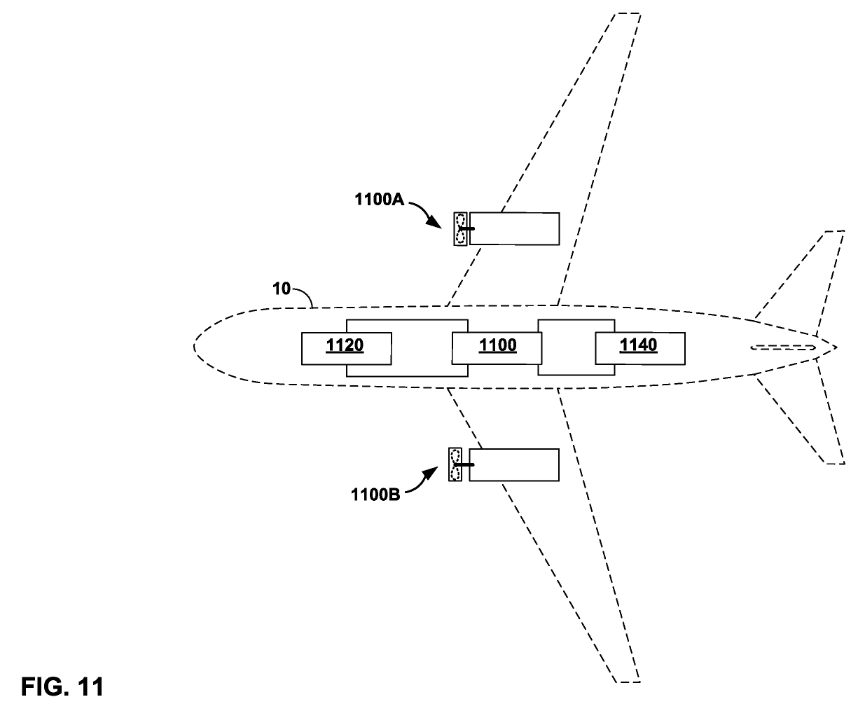

FIG. 11 is a conceptual diagram illustrating an example vehicle 10. Vehicle 10 may be vehicle 10 of FIG. 1, in accordance with one or more aspects of the disclosure. Vehicle 10 of FIG. 11 may be an aircraft that includes one or more turbine, propeller or electric engines 1100A and 1100B (collectively, “turbine engines 1100”), which may provide thrust and/or electrical power to vehicle 10. Examples of vehicle 10 include, but are not limited to fixed wing aircraft, rotorcraft, spacecreaft and the like. Ground-based systems are also possible.

Vehicle 10 or components thereof may generate thermal energy as constant load 1120 and transient load 1140. One or both of constant load 1120 and transient load 1140 may be cooled by thermal energy management system 1100, which may be an example of thermal energy management system 100 of FIG. 1. As such thermal energy management system 1100 may include a multi-stage thermal storage device, in accordance with one or more examples of the present disclosure.

The following numbered clauses illustrate one or more aspects of the devices and techniques described herein:

Clause 1: A thermal storage device includes a housing containing a cavity, the housing defining a working fluid inlet at an upstream end and a working fluid outlet at a downstream end; one or more working fluid passages disposed in the cavity, the one or more working fluid passages fluidically connecting the working fluid inlet and the working fluid outlet; and a phase-change material (PCM) surrounding the one or more working fluid passages, wherein the thermal storage device includes a first stage and a second stage, the second stage downstream of the first stage and separated from the first stage, wherein the first stage defines a first stage weight per unit of volume, the second stage defines a second stage weight per unit of volume, and the first weight per unit of volume is lower than the second weight per unit of volume.

Clause 2: The thermal storage device of clause 1, wherein: the first stage defines a first geometry, the second stage defines a second geometry, and the first geometry is different than the second geometry.

Clause 3: The thermal storage device of any of clauses 1 and 2, wherein: the first stage defines a first axial length, the second stage defines a second axial length, and the first axial length is larger than the second axial length.

Clause 4: The thermal storage device of any of clauses 1 through 3, further comprising a third stage, wherein the third stage is disposed between the first stage and the second stage.

Clause 5: The thermal storage device of any of clauses 1 through 4, wherein the first stage is configured as a lightweight stage, and wherein the second stage is configured as a high-efficiency stage.

Clause 6: The thermal storage device of any of clauses 1 through 5, wherein: the first stage defines a first volume of phase-change material, the second stage defines a second volume of phase-change material, and wherein the first volume is larger than the second volume.

Clause 7: The thermal storage device of any of clauses 1 through 6, wherein: the thermal storage device is configured to absorb a maximum amount of thermal energy before the phase-change material changes from completely solid to completely liquid, and wherein the first stage is configured to absorb at least 70 percent of the maximum amount of thermal energy.

Clause 8: The thermal storage device of any of clauses 1 through 7, wherein the first stage is separated from the second stage by a perforated wall.

Clause 9: The thermal storage device of any of clauses 1 through 8, wherein the first stage and the second stage are integral.

Clause 10: The thermal storage device of any of clauses 1 through 9, wherein the first stage is displaced from the second stage by a length of manifolding configured to transport working fluid between the first stage and the second stage.

Clause 11: The thermal storage device of any of clauses 1 through 10, wherein: the first stage includes a first phase-change material, the second stage includes a second phase-change material, and the second phase-change material is different than the first phase-change material.

Clause 12: The thermal storage device of any of clauses 1 through 11, wherein the first stage defines a first weight per unit of length, the second stage defines a second weight per unit of length, and the first weight per unit of length is lower than the second weight per unit of length.

Clause 13: The thermal storage device of any of clauses 1 through 12, wherein: the first stage defines a first amount of overall heat transfer surface area per unit volume, the second stage defines a second amount of heat transfer surface area per unit volume, and the second amount of heat transfer area per unit volume is larger than the first amount of heat transfer area per unit volume.

Clause 14: The thermal storage device of any of clauses 1 through 13, wherein the one or more working fluid passages of the first stage are defined by a low-thermal conductance wall and associated structure and the one or more working fluid passages of the second stage are defined by a high-thermal conductance wall and associated structure.

Clause 15: The thermal storage device of clause 14, wherein the low-thermal conductance wall includes a plastic, and the high-thermal conductance wall includes a metal.

Clause 16: A method for manufacturing a thermal storage device includes forming a housing containing a cavity, the housing defining a working fluid inlet at an upstream end and a working fluid outlet at a downstream end; forming one or more working fluid passages in the cavity, the one or more working fluid passages fluidically connecting the working fluid inlet and the working fluid outlet; surrounding the one or more working fluid passages in the cavity with a phase-change material (PCM); and separating a first stage of the thermal storage device from a second stage of the thermal storage device, the second stage downstream of the first stage, wherein the first stage defines a first weight per unit of volume, the second stage defines a second weight per unit of volume, and the first weight per unit of volume is lower than the second weight per unit of volume.

Clause 17: The method of clause 16, wherein: the first stage defines a first geometry, the second stage defines a second geometry, and the first geometry is different than the second geometry.

Clause 18: The method of any of clauses 16 and 17, wherein the first stage includes a first PCM, the second stage includes a second PCM, and the first PCM is different than the second PCM.

Clause 20: The system of clause 19, wherein: the first stage defines a first geometry, the second stage defines a second geometry, and the first geometry is different than the second geometry.

Various examples have been described. These and other examples are within the scope of the following claims.

What is claimed is:

1. A thermal storage device comprising:
a housing containing a cavity, the housing defining a working fluid inlet at an upstream end and a working fluid outlet at a downstream end;
one or more working fluid passages disposed in the cavity, the one or more working fluid passages fluidically connecting the working fluid inlet and the working fluid outlet; and
a phase-change material (PCM) surrounding the one or more working fluid passages,
wherein the thermal storage device includes a first stage and a second stage, the second stage downstream of the first stage and separated from the first stage,
wherein the first stage defines a first stage weight per unit of volume, the second stage defines a second stage weight per unit of volume, and the first weight per unit of volume is lower than the second weight per unit of volume.

2. The thermal storage device of claim 1, wherein:
the first stage defines a first geometry, the second stage defines a second geometry, and
the first geometry is different than the second geometry.

3. The thermal storage device of claim 1, wherein:
the first stage defines a first axial length, the second stage defines a second axial length, and
the first axial length is larger than the second axial length.

4. The thermal storage device of claim 1, further comprising a third stage, wherein the third stage is disposed between the first stage and the second stage.

5. The thermal storage device of claim 1, wherein the first stage is configured as a lightweight stage, and wherein the second stage is configured as a high-efficiency stage.

6. The thermal storage device of claim 1, wherein:
the first stage defines a first volume of phase-change material,
the second stage defines a second volume of phase-change material, and
wherein the first volume is larger than the second volume.

7. The thermal storage device of claim 1, wherein:
the thermal storage device is configured to absorb a maximum amount of thermal energy before the phase-change material changes from completely solid to completely liquid, and
wherein the first stage is configured to absorb at least 70 percent of the maximum amount of thermal energy.

8. The thermal storage device of claim 1, wherein the first stage is separated from the second stage by a perforated wall.

9. The thermal storage device of claim 1, wherein the first stage and the second stage are integral.

10. The thermal storage device of claim 1, wherein the first stage is displaced from the second stage by a length of manifolding configured to transport working fluid between the first stage and the second stage.

11. The thermal storage device of claim 1, wherein:
the first stage includes a first phase-change material, the second stage includes a second phase-change material, and
the second phase-change material is different than the first phase-change material.

12. The thermal storage device of claim 1, wherein the first stage defines a first weight per unit of length, the second stage defines a second weight per unit of length, and the first weight per unit of length is lower than the second weight per unit of length.

13. The thermal storage device of claim 1, wherein:
the first stage defines a first amount of overall heat transfer surface area per unit volume,
the second stage defines a second amount of heat transfer surface area per unit volume, and
the second amount of heat transfer area per unit volume is larger than the first amount of heat transfer area per unit volume.

14. The thermal storage device of claim 1, wherein the one or more working fluid passages of the first stage are defined by a low-thermal conductance wall and associated structure and the one or more working fluid passages of the second stage are defined by a high-thermal conductance wall and associated structure.

15. The thermal storage device of claim 14, wherein the low-thermal conductance wall includes a plastic, and the high-thermal conductance wall includes a metal.

16. A method for manufacturing a thermal storage device, the method comprising:
forming a housing containing a cavity, the housing defining a working fluid inlet at an upstream end and a working fluid outlet at a downstream end;
forming one or more working fluid passages in the cavity, the one or more working fluid passages fluidically connecting the working fluid inlet and the working fluid outlet;
surrounding the one or more working fluid passages in the cavity with a phase-change material (PCM); and
separating a first stage of the thermal storage device from a second stage of the thermal storage device, the second stage downstream of the first stage,
wherein the first stage defines a first weight per unit of volume, the second stage defines a second weight per unit of volume, and the first weight per unit of volume is lower than the second weight per unit of volume.

17. The method of claim 16, wherein:
the first stage defines a first geometry, the second stage defines a second geometry, and
the first geometry is different than the second geometry.

18. The method of claim 16, wherein the first stage includes a first PCM, the second stage includes a second PCM, and the first PCM is different than the second PCM.

19. A thermal energy management system for an aircraft, the system comprising
a working fluid circuit;
a pump configured to move circulate a working fluid through the working fluid circuit; and
a thermal storage device fluidically connected to the working fluid circuit, the thermal storage device comprising:
a housing containing a cavity, the housing defining a working fluid inlet at an upstream end and a working fluid outlet at a downstream end;
one or more working fluid passages disposed in the cavity, the one or more working fluid passages fluidically connecting the working fluid inlet and the working fluid outlet; and
a phase-change material (PCM) surrounding the one or more working fluid passages,
wherein the thermal storage device includes a first stage and a second stage, the second stage downstream of the first stage and separated from the first stage,
wherein the first stage defines a first weight per unit of volume, the second stage defines a second weight per unit of volume, and the first weight per unit of volume is lower than the second weight per unit of volume.

20. The system of claim 19, wherein:
the first stage defines a first geometry, the second stage defines a second geometry, and
the first geometry is different than the second geometry.
